(19) United States
(12) Patent Application Publication
(10) Pub. No.: US 2013/0293101 A1
(43) Pub. Date: Nov. 7, 2013

(54) DISCHARGE LAMP HAVING A DISCHARGE VESSEL AND MERCURY FILLING

(71) Applicants: Stephan Appel, Augsburg (DE); Armin Konrad, Grossaitingen (DE)

(72) Inventors: Stephan Appel, Augsburg (DE); Armin Konrad, Grossaitingen (DE)

(73) Assignee: OSRAM GMBH, Muenchen (DE)

(21) Appl. No.: 13/979,182

(22) PCT Filed: Dec. 16, 2011
(86) PCT No.: PCT/EP2011/073123

§ 371 Date: Jul. 11, 2013

(30) Foreign Application Priority Data
Jan. 13, 2011 (DE) 10 2011 002 634.7

(51) Int. Cl. H01J 61/35

(52) U.S. Cl. CPC H01J 61/35
USPC 313/635; 445/58

(57) ABSTRACT

A discharge lamp having a mercury-filled discharge vessel, a shatterproofing layer on the outside of the discharge vessel, and a contamination protection material applied to the inner face of the shatterproofing layer is disclosed. In case of breakage, discharge vessel shards are held together by the shatterproofing layer, and the mercury is bonded to the contamination protection material.

### FIELD

The present invention relates to a discharge lamp, and in particular to a low-pressure discharge lamp, having a discharge vessel and a mercury filling therein, to a method for the production of such a discharge lamp and to its use.

### PRIOR ART

In the case of low-pressure discharge lamps, to which the invention is not however restricted, a filling consisting of a base gas, for example a noble gas or a noble gas mixture, and a small amount of mercury, is provided in a glass discharge vessel. The mercury, which is in the vapor phase during operation, is then ionized by means of electrodes typically introduced at opposite sides of the discharge vessel, so that light generation takes place in a low-pressure plasma. The light, primarily emitted in the ultraviolet range at 254 and 185 nm, is then generally converted into visible light by a luminescent material provided internally on the discharge vessel, or is used directly.

### SUMMARY OF THE INVENTION

It is an object of the present invention to provide a particularly advantageous configuration of a discharge lamp having a discharge vessel and a mercury filling therein. According to the invention, this object is achieved by a discharge lamp having
an outer protection layer, configured as a splinter protection layer which holds discharge vessel wall fragments together in the event of fracture, provided externally with respect to a wall of the discharge vessel, and
a contamination protection material that absorbs mercury in the event of fracture, which is provided internally with respect to the outer protection layer.

Such a discharge lamp thus has a discharge vessel in which a mercury filling is provided, and a splinter protection layer for holding discharge vessel wall fragments together in the event of fracture, the splinter protection layer being provided externally with respect to a wall of the discharge vessel. It furthermore has a contamination protection material for binding mercury in the event of fracture, which is provided internally with respect to the splinter protection layer. Thus, for example, if a mechanical shock acts on the discharge lamp, as a result of which the discharge vessel breaks, the splinter protection layer reduces or prevents free splinter formation, and thus reduces the number of loose discharge vessel wall fragments. To this end, the splinter protection layer, which may in this case also be perforated by splinters, is for example at least locally adjacent to the discharge vessel wall and then holds fragments adhering to the splinter protection layer together or, for instance, in the case of a splinter protection layer not adjacent to the discharge vessel, or not adhering thereon, it holds the fragments together in a volume.

The contamination protection material provided internally with respect to the splinter protection layer and externally with respect to the discharge vessel wall may, for example as a layer provided over a large area, absorb the mercury generally, that is to say independently of any specific fracture geometry, or as material provided pointwise it may absorb mercury when damage to the corresponding region occurs. In particular when the splinter protection layer is then put at particular risk, for example by edge formation, the lamp is thus additionally secured (contamination protection material provided over a large area can naturally also fulfill this function). A splinter protection layer undamaged in the event of discharge vessel fracture may furthermore delimit a volume for the interaction of the mercury with the contamination protection material, which makes the use of the latter particularly effective.

In the layer system according to the invention, the contamination protection material can thus advantageously be used on the one hand for additional safety, for instance when the splinter protection layer is damaged and mercury could escape; thus, the contamination protection layer provides safety in addition to sealing by the splinter protection layer. On the other hand, in the case of an undamaged splinter protection layer, this can also hold the mercury together in a restricted space, per se directly increases the safety and can furthermore promote effective binding of the mercury by the contamination protection material.

The contamination protection material may in this case be dosed in such a way that the amount of mercury contained in the discharge lamp is fully bound by the contamination protection material.

If the discharge vessel is provided in an additional translucent vessel, for example, for instance for aesthetic reasons in a hollow bulb in the form of a conventional incandescent bulb, the splinter protection layer may also be provided externally with respect to a wall of the additional vessel (and therefore also externally with respect to the discharge vessel wall); the contamination protection material may then, for example, be arranged between the two vessels or between the splinter protection layer and the additional vessel (and therefore inside the splinter protection layer).

In general, the splinter protection layer provided externally with respect to a discharge vessel wall may also extend onto other components of the discharge lamp, which is to say, for example, it is also provided at least locally on a lamp cap. Then, either the splinter protection layer per se may adhere directly on the cap or in order to improve the adhesion, for example, an additional adhesion promoter may also be provided so that detachment of the splinter protection layer from the cap and therefore escape of mercury, or loss of contamination protection material, is counteracted.

Preferred configurations of the invention are specified in the dependent claims. In this context, throughout the whole disclosure, distinction is not made in detail between the description of the discharge lamp and its production, or use; the disclosure is implicitly to be interpreted with respect to all categories.

In a first embodiment, the contamination protection material is at least partially provided on a cap of the discharge lamp. The cap may, for example, be fitted at the end of a tubular discharge vessel onto an electrode frame fused into the discharge vessel, in which case it allows mechanical fastening of the lamp in a light and electrical supply via contact pins or screw cap contacts.

The contamination protection material may, for example, be provided both on the discharge vessel and on the cap, which is then also covered by the splinter protection layer at least in these regions, or only on the cap (in turn correspondingly covered by the splinter protection layer), and thus, for instance, may then ensure a particularly stable splinter protection layer, and which cannot be destroyed by splinters under conventional conditions, only in the region of the cap, which can be deformed by mechanical action. Furthermore, with a contamination protection material provided on the cap, escape of mercury can also be prevented when, for instance, the electrode frame breaks and damage to the discharge vessel thus occurs close to an installation plate provided for potential separation of the contact pins, which is typically perforated for evaporation of cap cement and therefore itself does not prevent an escape of mercury.

In another configuration, a surface extent of the contamination protection material amounts to at least 25%, increasingly preferably in this order at least 30, 35, 40, 45, 50, 55, 60, 65, 70, 75, 80, 85, 90, 95, of the discharge vessel wall outer surface; the two areas may also correspond to one another, and the surface extent of the contamination protection material may furthermore exceed the discharge vessel wall outer surface, if a cap is also coated. The contamination protection material is thus provided over a large area with a significantly greater extent in two dimensions, i.e. in the not necessarily planar surface, to which the size indications refer, than in the third dimension relating to the thickness. The contamination protection material is thus essentially distributed two-dimensionally. The surface extent is in this case considered as a sum, i.e. for example the contamination protection material may also be provided in the form of separate strips with a large area in total. Owing to the contamination protection layer provided over a large area, contact between contamination protection material and mercury, which can then be bound, takes place in the event of fracture substantially independently of the specific fracture geometry.

In another configuration, the surface extent of the contamination protection material, again configured as a sum, amounts to at most 5%, increasingly preferably in this order at most (4.5), 4, (3.5), 3, (2.5), 2, of the discharge vessel wall outer surface, so that, for instance, escape of mercury is prevented at a position with particularly high risk. On the other hand, in a volume delimited, preferably delimited in a sealed manner, by the splinter protection layer, a small area of the contamination protection material can also absorb the mercury, even fully over a prolonged period of time; by combination of the two layers, particularly sparing use of contamination protection material is therefore also possible.

In this configuration, furthermore, a contamination protection material which is not transmissive or is only partially transmissive for the light of the discharge lamp, for example, is also suitable because the light emitted in total is then scarcely affected owing to the small area.

The contamination protection material may, for example, also be applied in the form of a marking and thus additionally carry information, for instance about the lamp type, the series and/or the color temperature.

In another configuration, a splinter protection layer made of polymer material is provided, for instance of elastic silicone rubber, polyolefin, polyester, polycarbonate, crosslinked polyethylene (CPE), polymethyl methacrylate (PMMA) and/or poly(tetrafluoroethylene/hexafluoropropylene) (FEP). The polymer material may be selected as a function of the requirements so that a particularly scratch-resistant protection layer, which is therefore suitable for sealed containment of the splinters, may be formed, for instance from FEP.

In this case, in another configuration, an amalgam former and/or an oxidizing agent as a precursor of an amalgam former is provided as contamination protection material. An amalgam former is a metal which forms an alloy with mercury, with which the mercury then forms a single-phase or multiphase system.

In this case, tin and/or copper and/or silver and/or gold and/or zinc and/or indium is/are preferred as amalgam formers, in which case a gold compound and/or a silver compound may also more preferably be provided. For example, silver nitrate and/or silver carbonate may be provided as oxidizing agents, that is to say a precursor of the silver which then forms an alloy with the mercury.

As contamination protection material, however, it is also possible to provide an oxidizing agent which, after its reduction, does not constitute an amalgam former but itself forms a compound with the mercury. Sulfur, with which mercury forms stable mercury sulfides, is preferred as an oxidizing agent.

In another configuration, the contamination protection material is in particle form with an average particle size of less than 50 μm, increasingly preferably in this order less than 40, 30, 20, 10, 5, 3, 2, 1 μm. Owing to the particularly preferred particle size lying in the nanocrystalline range, for example, on the one hand the area available for the interaction with the mercury can be increased and, on the other hand, for instance, contamination protection layers which are improved in respect of their optical properties can also be produced. Thus, the transmission properties can be improved by reducing the average particle size, which for example also permits large-area application of the contamination protection material.

The invention also relates to a method for producing a corresponding discharge lamp, wherein the contamination protection material is provided on the discharge lamp in a first step, and the splinter protection layer is applied in a second step. In this way, in particular, it is also possible to facilitate the application of the contamination protection material, which for instance in the simplest case may be sprayed or spread on as a suspension; elaborate embedding of the contamination protection material in a matrix is not necessary.

The contamination protection material is then provided as a layer separate from the splinter protection layer, for instance as a layer in powder form between the discharge vessel and the splinter protection layer, and can thus be released or exposed in the event of discharge vessel fracture, and in this way can interact particularly effectively with the mercury.

The splinter protection layer may, for example, be produced by an extrusion method, which is suitable for instance for polycarbonate or FEP.

In another configuration, the contamination protection material is applied by an indirect printing method, in particular by a pad printing method. In this case, a pad takes a printing image, for instance a type designation to be applied, from an image plate and then adapts to the shape of the discharge lamp during the printing owing to its elastic properties. As printing material, for example, varnish with suspended particles, preferably suspended nanoparticles, may be provided.

The invention also relates to the use of a corresponding discharge lamp for the illumination of foodstuffs, for instance illumination in food production, and/or illumination in installations which are associated with food production, for example producing packaging material for foodstuffs.

Furthermore, the invention also relates to the use of a corresponding discharge lamp in an earthquake-proof building.

### BRIEF DESCRIPTION OF THE EXEMPLARY EMBODIMENTS

The invention will be explained in more detail below with the aid of exemplary embodiments; the individual features may also be essential to the invention in another combinations, and they implicitly refer to all categories of the invention.

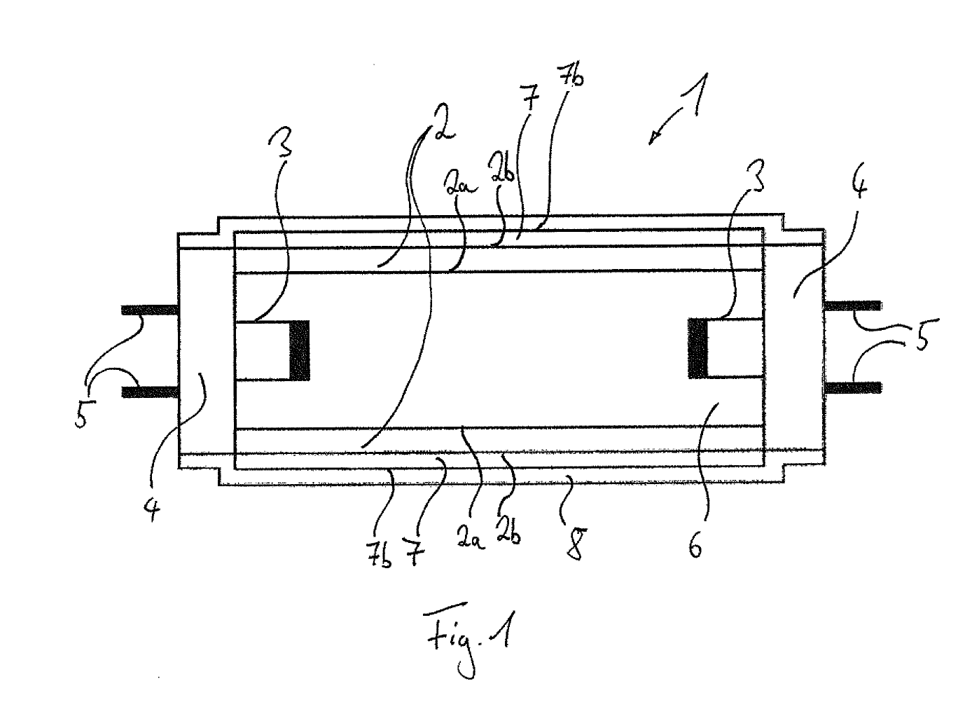

FIG. 1 shows a longitudinal section through a discharge lamp having a contamination protection layer provided on the discharge vessel.

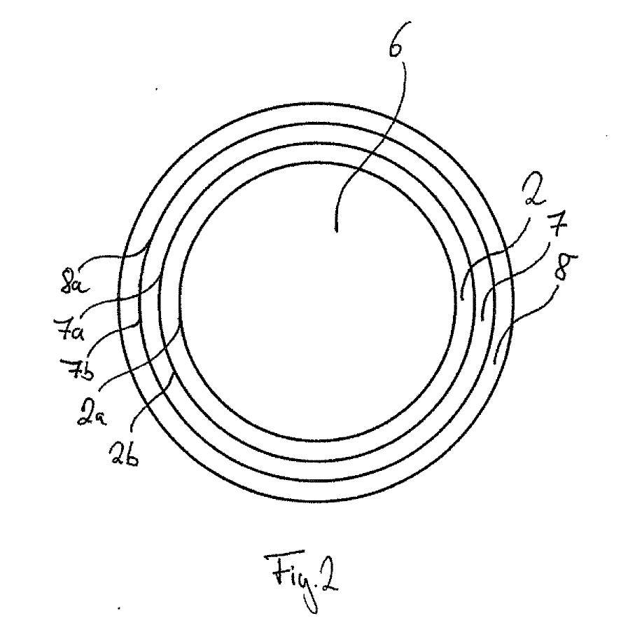

FIG. 2 illustrates the layer structure of the discharge lamp of FIG. 1 in a section perpendicular thereto.

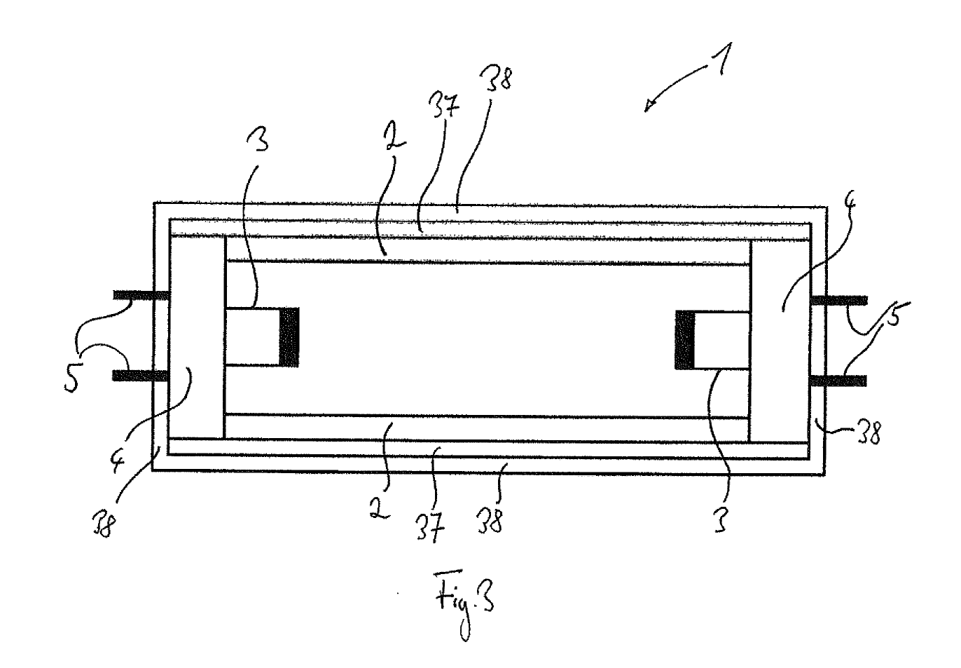

FIG. 3 shows a contamination protection material provided on the discharge vessel and cap, in connection with a splinter protection layer fully surrounding the lamp.

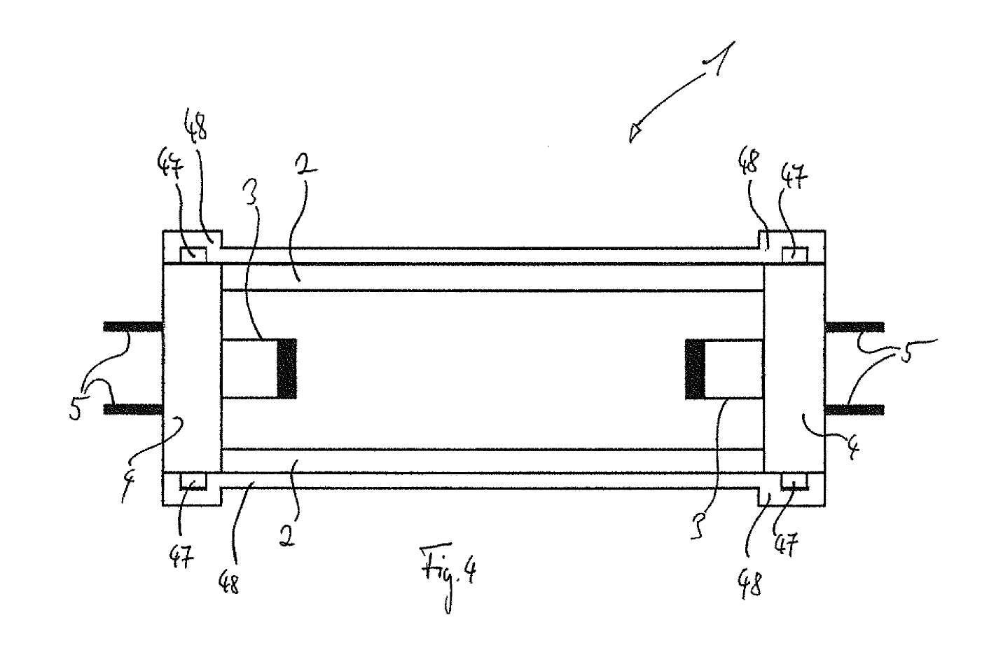

FIG. 4 illustrates a discharge lamp having a contamination protection layer provided only on the caps.

The low-pressure discharge lamp 1 formed as a fluorescent lamp is constructed from a discharge vessel 2, which in this case is linearly tubular, into which electrode frames 3 are fused at two opposite end sides. The fluorescent lamp 1 is then held in a light by means of caps 4, likewise provided on the end side, and the electrode frames 3 are electrically contacted via contact pins 5 emerging from the caps 4.

A filling of noble gases and about 2 mg of mercury is provided in the volume 6 delimited in part by the inner wall surface 2a of the discharge vessel 2.

Adjacent to the outer wall surface 2b of the discharge vessel 2, there is a contamination protection layer 7 made of silver nitrate and silver carbonate particles with an average particle size of less than 1 μm. If fracture of the discharge vessel 2 occurs, the contamination protection layer 7 comes in contact with the volume 6 at least locally at fracture points; the silver nitrate or silver carbonate is reduced to silver, which then binds the mercury as an amalgam.

By an FEP splinter protection layer 8 adjacent to the outer side 7b of the silver nitrate/carbonate layer 7 and extending over the caps as far as their end sides, the individual splinters are held inside the volume delimited by the caps 4 and the splinter protection layer 8 in the event of fracture. The silver nitrate/carbonate present in excess with respect to the mercury can then likewise fully absorb the mercury restricted to this volume. During disposal, on the one hand the splinters are held together and, on the other hand, the mercury is bound. In order to improve the sealing by the splinter protection layer 8, an additional adhesion promoter may also be provided between the latter and the caps 4.

As an alternative to FIG. 1, the contamination protection layer 7 may also be discontinuous, for example in the form of parallel circumferential rings or parallel longitudinally directed strips, so that the splinter protection layer 8 directly adjoins the outer surface 2b of the discharge vessel 2 in the region of the discontinuities. Depending on the adhesion properties between the splinter protection layer 8 and the discharge vessel 2, splinters are also held together when the protection layer 8 is partially destroyed in the event of fracture.

FIG. 2 shows a section, arranged perpendicularly to the plane of the drawing of FIG. 1 and between the electrodes 3, through the fluorescent lamp 1 represented therein. The contamination protection layer 7, which is itself encapsulated by the splinter protection layer 8 adjacent to it, adjoins the discharge vessel 2 enclosing the volume 6.

In FIGS. 3 and 4, parts with the same references as in FIG. 1 have the function described above.

In the discharge lamp according to FIG. 3, the contamination protection layer 37 adjoins the lamp vessel 2 and also extends over the caps 4 as far as their end side. The FEP splinter protection layer 38 fully encapsulates the fluorescent lamp 1, i.e. it also extends over the end sides of the caps 4 and only exposes openings for the contact pins 5.

In the embodiment according to FIG. 4, the contamination protection material 47 applied by an intaglio printing method, consisting of silver, copper and/or zinc, is provided only on the caps 4 of the fluorescent lamp 1. Since the splinter protection layer 48 of 0.2-0.5 mm thick FEP is sufficiently resistant to damage by splinters, escape of mercury can occur primarily in the region of a cap 4 deformed by mechanical action. For this reason, the contamination protection material 47 is provided as circumferential barriers on the caps 4.

1. A discharge lamp comprising:
a discharge vessel in which a mercury filling is provided,
a splinter protection layer for holding discharge vessel wall fragments together in the event of fracture, which splinter protection layer is provided externally with respect to a wall of the discharge vessel, and
a contamination protection material for binding mercury in the event of fracture, which contamination protection material is provided internally with respect to the splinter protection layer.

2. The discharge lamp as claimed in claim 1, wherein the contamination protection material is at least partially provided on a cap of the discharge lamp.

3. The discharge lamp as claimed in claim 1, wherein a surface extent of the contamination protection material amounts to at least 25% of the discharge vessel wall outer surface.

4. The discharge lamp as claimed in claim 1, wherein a surface extent of the contamination protection material amounts to at most 5% of the discharge vessel wall outer surface.

5. The discharge lamp as claimed in claim 1, wherein the splinter protection layer made of polymer material, in particular of at least one of silicone rubber, polyolefin, polyester, polycarbonate, crosslinked polyethylene, polymethyl methacrylate and poly(tetrafluoroethylene/hexafluoropropylene).

6. The discharge lamp as claimed in claim 1, wherein the contamination protection material contains at least one of an amalgam former and an oxidizing agent as a precursor of an amalgam former.

7. The discharge lamp as claimed in claim 6, wherein the contamination protection material contains at least one of tin, copper, silver, gold, zinc and indium.

8. The discharge lamp as claimed in claim 7, wherein the contamination protection material contains at least one of a gold compound and a silver compound, in particular at least one of a silver nitrate and a silver carbonate.

9. The discharge lamp as claimed in claim 1, wherein the contamination protection material contains an oxidizing agent as a precursor of a mercury compound.

10. The discharge lamp as claimed in claim 1, wherein the contamination protection material is in particle form with an average particle size of less than 50 μm.

11. A method for producing a discharge lamp as claimed in claim 1 comprising:
applying the contamination protection material, and applying the splinter protection layer.

12. The method for producing a discharge lamp as claimed in claim 11, wherein the contamination protection material is applied by an indirect printing method.

13. (canceled)

14. The discharge lamp as claimed in claim 2, wherein a surface extent of the contamination protection material amounts to at least 25% of the discharge lamp cap outer surface.

15. The discharge lamp as claimed in claim 2, wherein a surface extent of the contamination protection material amounts to at most 5% of the discharge vessel cap outer surface.

16. The discharge lamp as claimed in claim 2, wherein the contamination protection material contains at least one of an amalgam former and an oxidizing agent as a precursor of an amalgam former.

17. The discharge lamp as claimed in claim 16, wherein the contamination protection material contains at least one of tin, copper, silver, gold, zinc and indium.

18. The discharge lamp as claimed in claim 17, wherein the contamination protection material contains at least one of a gold compound and a silver compound, in particular at least one of a silver nitrate and a silver carbonate.

19. The discharge lamp as claimed in claim 17, wherein the contamination protection material contains an oxidizing agent as a precursor of a mercury compound.

20. The discharge lamp as claimed in claim 17, wherein the contamination protection material is in particle form with an average particle size of less than 50 μm.
